(19) United States
(12) Patent Application Publication
(10) Pub. No.: US 2018/0137951 A1
(43) Pub. Date: May 17, 2018

(54) CABLE, METHOD FOR PRODUCING A CABLE AND EXTRUSION UNIT

(71) Applicant: LEONI KABEL GMBH, NUERNBERG (DE)

(72) Inventor: JOERG WENZEL, ROTH (DE)

(21) Appl. No.: 15/854,109

(22) Filed: Dec. 26, 2017

Related U.S. Application Data
(63) Continuation of application No. PCT/EP2016/064112, filed on Jun. 20, 2016.

(30) Foreign Application Priority Data
Jun. 24, 2015 (DE) 10 2015 211 762.6

(51) Int. Cl. H01B 7/00; H01B 7/02; H01B 13/14; H01B 7/04

(52) U.S. Cl. CPC H01B 7/0081; H01B 7/0216; B29C 47/025; H01B 7/04; H01B 13/141; H01B 13/147

(57) ABSTRACT

A cable having at least one conductor which extends in a longitudinal direction and is enclosed by a jacket that is extruded onto the conductor. The jacket has a plurality of sections which are manufactured from different plastics, with results in the sections having different functionality. As a result, properties of the cable on a respective section are optimally adapted to the requirements of the respective section. There is also described a method for producing such a cable and to an extrusion unit for extruding the jacket with a plurality of sections.

### CROSS-REFERENCE TO RELATED APPLICATION

This application is a continuation, under 35 U.S.C. § 120, of copending international application No. PCT/EP2016/064112, filed Jun. 20, 2016, which designated the United States; this application also claims the priority, under 35 U.S.C. § 119, of German patent application No. DE 10 2015 211 762.6, filed Jun. 24, 2015; the prior applications are herewith incorporated by reference in their entirety.

### BACKGROUND OF THE INVENTION

### Field of the Invention

The invention relates to a cable, to a method for producing a cable, and to an extrusion unit for use in a process for producing a cable.

Cables usually have a cable core which is sheathed by a jacket. The jacket herein is typically applied to the cable core in an extrusion method. To this end, the cable core is conveyed through an extrusion head of an extrusion unit and the respective material meanwhile is fed as a pliable compound. In order for the material to be provided, the extrusion unit usually has an extruder, for example in the form of a screw conveyor. The material is typically a plastics material.

Depending on the field of application of the cable, the jacket is made from a suitable material which is selected according to specific criteria such as, for example, elasticity, bending flexibility, heat resistance, media resistance, or media tightness. However, in terms of the jacket there are often a plurality and potentially even mutually exclusive requirements that have to be met simultaneously and which in certain circumstances lead to compromises in the selection of material or lead to a diminished performance of the cable in terms of at least one of the plurality of criteria.

It is typically advantageous for the cable to be particularly flexurally flexible, on the one hand, while, on the other hand, entangling and interlacing of the cable can be avoided in a simpler manner by using a more rigid plastics material.

### SUMMARY OF THE INVENTION

It is accordingly an object of the invention to provide a method of producing a cable which overcomes the above-mentioned and other disadvantages of the heretofore-known devices and methods of this general type and which provides for a cable which in terms of the jacket thereof is capable of being designed in a particularly diverse manner and hereby is to be produced in as simple a manner as possible. Furthermore, it is an object to provide for a production method for such a cable and an extrusion unit for the method.

With the foregoing and other objects in view there is provided, in accordance with the invention, a method for producing a cable, the method comprising:
extruding a jacket onto a conductor by way of an extrusion head;
forming the jacket with a plurality of portions that are made from dissimilar plastics materials; and
feeding each of the dissimilar plastics materials by a respective pressure-controlled feed unit having an adjustable conveying quantity.

The cable has at least one conductor, in general in particular one cable core, which extends in a longitudinal direction and is surrounded by a jacket. This jacket is extruded onto the conductor and has a plurality of portions, or segments, or sections, which are made from dissimilar plastics materials.

A primarily important concept of the invention in particular lies in that the cable has a plurality of portions on which the jacket, depending on the requirements set for the respective portion, is made from a correspondingly suitable material. On account thereof, the portions on the cable and in terms of the jacket can be implemented as dissimilar functional portions which are then configured in a targeted manner with a view to the respective application of the portion. In other words, the plastics material from which the jacket for a specific portion is made is in each case selected in a targeted manner in terms of the special requirements set for this portion.

On account of the jacket being made entirely from plastics materials, said jacket is advantageously completely extrudable and the cable, on account thereof, can be produced in a particularly simple manner. A further advantage in the use of plastics materials particularly lies in that the portions can be interconnected in a materially integral manner and thus in a particularly robust manner and preferably are interconnected in a correspondingly materially integral manner. This is achieved inter alia in particular on account of preferably only one extrusion unit being used for configuring the plurality of portions of the jacket, the entire jacket being extruded by means of said one extrusion unit. This extrusion unit in this instance comprises an extrusion head by way of which the plurality of portions are applied to the conductor in particular as a continuous and contiguous jacket.

In principle, all in particular extrudable plastics materials are suitable as the plastics material. However, such plastics materials which interconnect particularly well such that as positive a materially integral connection as possible is implemented are preferably used. For example, the plurality of plastics materials are in each case a PVC material but in dissimilar configurations, for example having a dissimilar degree of hardness. Also conceivable are various PE plastics materials or TPU plastics materials. In particular, the plurality of plastics materials represent dissimilar phases such that the cable accordingly has a multi-phase jacket. Therefore, in general all plastics materials which are mutually agreeable phases, that is to say which in particular are interconnectable, are suitable.

In one suitable design embodiment, at least two of the plastics materials are dissimilar in terms of hardness. On account thereof, in particular a plurality of portions having a dissimilar bending flexibility can be implemented. In this way, it is in particular possible in this instance for a so-called entanglement protection, for example for a headphone cable, to be implemented. The jacket herein in this instance has correspondingly hard and soft portions, wherein the soft portions in this instance ensure the required bending flexibility of the cable and the hard portions provide a certain degree of rigidity in order for entangling and/or interlacing of the cable to be avoided or to be at least reduced. On account of the configuration of a plurality of portions from dissimilarly hard plastics materials it is advantageously possible in this instance in particular by way of a suitable selection of the plastics materials and of the dimensioning and the mutual disposal of the plurality of portions for the bending flexibility and the rigidity of the cable to be mutually weighted and set in a suitable manner.

In general, various PVC plastics materials, for example, are suitable as dissimilar plastics materials. In the case of dissimilarly hard plastics materials, that is to say of a hard PVC and of a soft PVC, for example, wherein a hard PVC is to be understood in particular as a PVC having a Shore hardness, in particular a Shore A hardness, which is higher than the Shore hardness of the soft PVC by a factor of at least two. The relative hardnesses of the plastics materials used in relation to one another and not the absolute hardnesses are thus particularly of primary importance. In other words, the hard plastics material usually also has a certain elasticity but in comparison to the soft plastics material is more flexurally rigid. A suitable Shore hardness of the soft plastics material is approximately 88, for example.

Particularly in order for an entanglement protection to be configured for a cable, one of the portions is expediently configured as a spring element and extends continuously in the longitudinal direction. A spring element that is configured in this way ensures in an advantageous manner a homogenous restoring force along the entire cable in the case of bending, and thus prevents in particular an unintentional interlacing of the cable. The spring element in the cross section transversely to the longitudinal direction of the cable in this instance assumes a specific angular range or is disposed only in a specific angular range. Herein, various cross-sectional geometries of the spring element are initially conceivable, for example round, elliptic, or in one variant angular. The remaining jacket in this instance is made from another plastics material or from a plurality of other plastics materials.

The spring element is preferably configured in an encircling manner, in particular in a spirally encircling manner. The spring element herein is integrated in the jacket or is disposed so as to encircle the latter. The jacket per se in general is configured so as to be circular in the cross section, thus in particular has no preferred orientation as is the case with flat cables, for example.

In particular in the continuous configuration, the two portions are expediently configured simultaneously, that is to say that two dissimilar plastics materials are simultaneously extruded onto the conductor. To this end, the extrusion unit in this instance comprises two extruders, for example, such that the plurality of dissimilar plastics materials can be provided simultaneously and in particular continuously.

In one particularly advantageous refinement, the spring element extends in the manner of a helix about the conductor. The spring element in this instance is advantageously configured in the manner of a coil spring and in the flexing and in particular also the compression of the cable has a corresponding restoring force. The spring effect herein is achieved in particular in that the plastics material which is used for configuring the spring element is initially extruded in the form of a helix and then solidifies in this helical shape, on account of which the latter assumes the initial shape to which the plastics material when deformed automatically returns. In other words, the portion that is configured as a spring element is a plastics-material spring.

In one particularly preferred design embodiment, the spring element is made from a hard plastics material and the remaining jacket from a plastics material that in comparison to the former is soft. The spring element in this instance forms a hard portion of the jacket which is preferably embedded in a respective soft portion, that is to say is in particular integrated in the latter. In particular in the case of the helical shape, a comparatively softer plastics material is disposed in this instance between the various spirals of the spring element, said comparatively softer plastics material in this instance advantageously being sufficiently elastic and/or compressible in order to guarantee a certain degree of bending flexibility.

In one expedient variant, the spring element is configured as a flat strip and thus has a particularly low profile in the radial direction, that is to say perpendicularly to the longitudinal direction. The resulting cable in this instance is particularly compact. The spring element in this instance in the cross section is molded so as to be approximately rectangular, for example.

In one suitable design embodiment, the spring element and the remaining jacket are flush with one another, such that an outwardly smooth and homogenous jacket surface results. Particularly in such cases in which the jacket is an external jacket of the cable, catching of the cable on objects of the environment is avoided on account thereof, and a design embodiment that is particularly appealing in a haptic and visual manner is achieved at the same time.

In one likewise suitable alternative, the spring element on the remaining jacket by contrast is constructed, that is to say projects so to speak, transversely to the longitudinal direction, on account of which an improved grip on the cable is implemented in particular. When measured from the remaining jacket, the spring element in this instance in the radial direction has a height which is in particular approximately 5 to 50% of the diameter of the cable without the spring element. Also in this high-profile version, the spring element as a portion of the jacket is preferably connected to the remaining jacket in a materially integral manner such that any slipping of the spring element in relation to the remaining jacket is prevented in particular.

The spring element on the external side of the jacket preferably configures a number of delimitation elements which predefine a minimum bending radius of the cable. In particular in combination with the spring element that on the remaining jacket is constructed transversely to the longitudinal direction, the delimitation elements are in this case configured by the respective projecting parts of the spring element. The minimum bending radius herein is set in particular by a suitable choice of the height of the spring element. The radius of the cable at the respective locations is in this instance enlarged overall in a corresponding manner such that the delimitation elements in the bending of the cable result in a corresponding reinforcement or in the extreme case even contact one another and in this way delimit the bending radius of the cable to a minimum bending radius. In the case of the helical design embodiment of the spring element, the spring element in this instance accordingly has in particular only one likewise helically encircling delimitation element which correspondingly has a number of spirals which then form a reinforcement or when bent contact one another and prevent further bending.

A particularly simple production of the cable and in particular of the spring element results from a design embodiment in which the spring element is produced by means of a strip-extrusion method and in particular in a continuous manner. In the case of such a strip-extrusion method, a plurality of plastics materials are fed to an extrusion head of the extrusion unit, wherein one of the plastics materials by means of a strip-extrusion head having a strip distributor is configured as a strip portion along the cable. In order for a helical profile of the spring element to be configured, a rotating strip distributor which in particular in the continuous operation of the extrusion unit is then rotated about the conductor and in this way extrudes a helically shaped portion onto said conductor is used in this case.

In one expedient variant, the cable has an external jacket which surrounds the jacket and covers the latter toward the outside. The jacket per se in this instance is not an external jacket of the cable and is preferably not visible toward the outside. Further properties of the cable can be set in this way by means of the external jacket. For example, while the jacket in the manner mentioned above has a spring element having a corresponding restoring action, a uniform appearance or a shielding in relation to environmental influences is implemented in this case by the external jacket. The external jacket herein is preferably likewise extruded, for example by means of a downstream extrusion head in which the conductor having the surrounding jacket thereof serves as the incoming core. Alternatively, however, a wrapping is also conceivable, for example.

By contrast to the above-mentioned simultaneous configuration of a plurality of portions, in one advantageous variant a plurality of portions are sequentially disposed in the longitudinal direction. Said portions in production are in this instance configured in a corresponding sequential manner. In this way, functional portions of the cable that are correspondingly sequentially disposed can be implemented in this way. This is particularly advantageous in the case of such a cable which along the entire length thereof is to have different properties and/or dissimilar functionalities at various longitudinal positions.

In one first suitable variant, the portions in an alternating manner are configured as hard and soft portions, wherein the soft portions are configured as hinges. In this way, a cable which in a corresponding manner is flexural only at specific predefined longitudinal positions, that is to say in the soft portions, is configured in this instance, while the interdisposed hard portions are comparatively rigid in flexural terms. The cable in this instance in a corresponding manner has predetermined kinking locations, specifically the soft portions that are configured as hinges. Such a cable is suitable in such situations in which it is known from the outset how the cable is to be installed and at which locations bending is required, for example. By virtue of the use of a hard plastics material, the cable in the non-bent portions is configured so as to be correspondingly robust. The plurality of plastics materials herein are preferably selected as has been described above in the context of the spring element, that is to say so as to be of dissimilar relative hardnesses.

In general, a multiplicity of further suitable variants results in that at least two successive portions are made from plastics materials having dissimilar main properties. The main properties herein are selected from a group of main properties comprising: chemical properties, in particular media resistance; physical properties, in particular flame-resistance or temperature-resistance; electrical properties, in particular electromagnetic shielding or electrical isolation; mechanical properties, in particular hardness or elasticities; and price. In this way, a cable that in a portion-by-portion manner is configured and designed optimally and in which the jacket material at each longitudinal position is suitably selected so as to correspond to the respective requirement set for this longitudinal position is implemented.

Main property herein is understood in particular to be that property by way of which the respective plastics material is primarily distinguished and by virtue of which said plastics material is also primarily selected for the respective application. Such main properties relate in particular to physical, chemical, electrical, or mechanical properties of a respective plastics material. A media-resistant plastics material is thus in particular distinguished by a particular tightness in relation to an ingress of moisture, for example, or of specific gases, or by a certain resistance in relation to acids, oils, or other aggressive substances for example. Flame-resistance is in particular understood to mean that the plastics material is flame-resistant according to the relevant standards. A temperature-resistant plastics material is heat-resistant up to a specific predefined temperature, for example, and/or cold resistant and in this instance suitable for use in a particularly cold environment. In order for an electromagnetic shielding effect to be achieved, a plastics material includes metal particles, for example, or is in general an electrically conducting plastics material, whereas an electrically isolating plastics material in a corresponding manner is non-conducting and has a particularly high dielectric strength, for example, that is to say a particularly high dielectric value. A plastics material that is selected in terms of the mechanical properties is fiber-reinforced, for example, and on account thereof is particularly resistant to tensile forces or is particularly elastic. All portions which do not have to have any particular physical, chemical, electrical, or mechanical properties, are in this instance expediently made from plastics material that is as cost-effective as possible.

For example, a cable for an on-board network of a motor vehicle is to be routed past a warm part of the motor vehicle, for example the motor, only by way of a specific longitudinal portion, and in the remaining longitudinal portions does not have to meet any further requirements. In the case of this cable, a first portion having the criterion of temperature-resistance is configured in this instance from a plastics material which is temperature-resistant in a suitable manner. The remaining jacket in this instance is however made from a particularly cost-effective plastics material since the temperature-resistance herein is of lesser importance. The entire cable herein is 5 m long, for example, wherein only 1 m as the first portion is embodied in a corresponding temperature-resistant manner.

In a second example, a cable is to be routed through an oil pan and in the first portion that correspondingly runs within the oil pan is to be sufficiently media-tight and/or media-resistant. This portion at either end is adjoined by in each case one sealing portion which is routed through a lead-through of the oil pan and is to seal the latter. The first portion in this instance is expediently made from a media-tight and/or media-resistant plastics material, while the adjoining sealing portions are made from a sealing and preferably elastic plastics material in order for the lead-through to be effectively closed. The remaining portions of the cable in this instance are expediently adapted in a corresponding manner to other requirements.

In general, the cable in the longitudinal direction is thus subdivided into dissimilar portions for which there are dissimilar requirements as demanded by the application, in particular in terms of the above-mentioned properties. The cable is now advantageously configured precisely in such a manner that in each case an optimally suitable plastics material is selected in the respective portions and a jacket which in the longitudinal direction is made from correspondingly selected plastics materials is configured in this way.

In one particularly preferred design embodiment, the plastics materials of two respective successive portions are not mixed with one another but configure an interface which runs substantially transversely to the longitudinal direction and on which an in particular materially integral connection of the two plastics materials is configured. The portions in this way are configured in a particularly defined manner, that is to say that the formation of a mixed zone in which both plastics materials are simultaneously present and on account thereof possibly influence the properties of the jacket in a negative manner is advantageously avoided. Accordingly, this results in a defined transition from one portion to the subsequent portion without the usual mixing of the various plastics with one another as is otherwise usual in the case of conventional extrusion units. “Not mixing with one another” is thus to be understood in particular that the defined transition if at all has only a short mixed zone which is significantly shorter than the mixed zone configured in a conventional manner. This separation is achieved in particular in that the feed of plastics material at the end of the one portion is completely interrupted, and the feed of another plastics material is then activated in order for the subsequent portion to be configured. However, by virtue of the usually prevalent pressure conditions herein it is possible that a bulge is configured on the interface where the two portions bear on one another, said bulge however having only minor dimensions, meaning that said bulge in particular in the longitudinal direction extends by less than one centimeter. However, this is expediently avoided by way of a suitable regulation of the pressure in the plastics material feed.

In one suitable variant, the jacket is also an external jacket of the cable. Accordingly, the jacket in this instance is exposed in particular to environmental influences, and the advantageous properties of the selected plastics materials of the various portions are advantageously effective. Accordingly, the use of the jacket as the external jacket is particularly advantageous in the case of the configuration of the cable by way of a plurality of longitudinal portions since the plastics materials for the various longitudinal portions in the case of such a design embodiment are selected with a view to different environmental conditions.

In the method for producing the cable, the jacket is extruded onto the conductor by means of an extrusion head, wherein the jacket is configured so as to have a plurality of portions, and the portions are made from dissimilar plastics materials, that is to say in particular in a multi-phase manner. The method is thus an extrusion method, in particular a multi-phase extrusion in which preferably all of the plurality of plastics materials for the jacket are in each case fed to the extrusion head as a pliable compound or phase and in said extrusion head are applied to the jacket and shaped in a corresponding manner.

The dissimilar plastics materials are expediently fed to the extrusion head in an alternating manner by way of a switching element, in particular a branch. Preferably, a branch which is known per se for injection molding and which has a non-return flap by way of which a complete retention of the one plastics material is performed when another plastics material is being fed is used. The branch herein is embodied as a Y branch, for example, having two feeds for two plastics materials and one outlet for feeding the selected plastics material to the extrusion head. By switching the branch in a corresponding manner, the feed of the one plastics material is stopped and the feed of another plastics material is activated in an advantageously simultaneous manner. On account thereof, the configuration of a mixed zone is prevented in a particularly effective manner. Rather, the two successively configured portions are configured in a defined manner. To this end, the extrusion head furthermore preferably has a material volume that is as small as possible such that any mixing of dissimilar fed plastics materials is also prevented herein.

Extruders are usually used for feeding material in the case of extrusion units. However, said extruders disadvantageously have to be operated continuously, that is to say continuously convey the same quantity of material per unit of time. A respective extrusion unit in this instance represents in particular a tuned system in which the quantity of material conveyed by the extruder is adapted to the quantity of material that is extruded by means of the extrusion head. An in particular sudden change in the quantity of conveyed material is problematic herein. Such extrusion units are therefore suitable only to a limited extent for configuring portions from a plurality of in particular dissimilar plastics materials and are capable of being operated in combination with the switching element mentioned also only to a limited extent. Therefore, the dissimilar plastics materials in one preferred design embodiment are in each case provided by way of a feed unit having an adjustable conveying quantity, for example by way of a melt pump or an injection-molding apparatus. In other words, the quantity of material that is fed by a respective feed unit is adjustable to requirements and is also set to requirements.

In one suitable design embodiment, the feed units are pressure-controlled and in particular configured in each case as an injection-molding apparatus. Such injection-molding apparatuses for feeding material are in principle known in injection molding but in the case of extrusion methods are not usually used since a continuous and in particular consistent material feed is desired in the case of the latter, which is not guaranteed by the typically limited material volume of a respective feed unit. However, in the case of the configuration of a plurality of portions it is advantageously possible by using a respective plurality of feed units for the latter to be operated in an alternating manner, that is to say in a quasi-reciprocating manner, such that when plastics material is fed from one feed unit the other feed unit is thus not required and instead is charged with new material, for example.

As opposed to a conveyor screw (extruder screw) in the case of an extruder, a discontinuously operating feed unit in which the injection-molding or extrusion compound is thus not continuously conveyed is preferably used for the feed unit. For conveying, a pressure is exerted on the compound in the feed unit by way of a pressure-generating element, for example a (melt) pump or a ram. A pressure-controlled feed unit is therefore understood to be a feed unit which by means of such a pressure-generating element, which is precisely not a continuously operating extruder screw, builds up the pressure for the compound in particular in a discontinuous manner and/or feeds said pressure to an accumulator space for the next operating cycle in which the compound is again dispensed from the accumulator space. Therefore, an extruder screw in particular is dispensed with in order for the compound to be fed to the extrusion head.

In one suitable design embodiment, a plastics material is fed by means of a first feed unit and a first portion is configured, and upon configuration of this first portion, switching takes place to the second feed unit in particular by means of the switching element, wherein the first feed unit which is now not required can be newly recharged in a corresponding manner with plastics material. In principle, it is also possible herein for a plurality of feed units to be stocked with the same plastics material such that a correspondingly large material volume of this plastics material is then available. However, at least two feed units are preferably stocked with dissimilar plastics materials in order for dissimilar portions to be configured on the cable in a corresponding manner.

The extrusion unit in general is also suitable for extruding a stranded product, but in particular for extruding a jacket in the manner as described above. The extrusion unit having feed units, in particular melt pumps and/or injection-molding apparatuses, instead of extruders, is moreover particularly suitable for extruding portions which are extruded or molded sequentially in the longitudinal direction, but in principle is also suitable for producing a cable having in particular dual-phase or in general multi-phase portions that are continuous in the longitudinal direction. In general, the extrusion unit by virtue of the particular design embodiment of the feed units is in particular not an extrusion unit in the conventional sense, that is to say having an extrusion head and an extruder, but rather in particular a combination of an extrusion unit and an injection-molding unit in which the feed units of an injection-molding unit are combined with the shape-imparting element (extrusion head) of a conventional extrusion unit.

Therefore, in one suitable variant, in the production of the cable one of the portions alternatively or additionally is configured as a spring element and by means of a strip extrusion head is configured in particular as a continuous strip along the cable. In order for the plastics material to be fed for the purpose of configuring the spring element, in principle two embodiments can be considered in this case, specifically first the feed by way of injection-molding apparatuses as described above, in particular by way of a plurality of injection-molding apparatuses having a limited material volume, and second a feed by means of a conventional extruder.

Alternatively, it is also possible for the spring element to be provided as a semi-finished product and to be disposed about the conductor. In one preferred variant, to this end a portion of the jacket is configured as a spring element in that a plastics material for the spring element is initially provided as a strand which then is placed about the conductor in the manner of a helix and is subsequently heat-treated in order for the helical profile to be set. The remaining jacket in this instance is then additionally extruded in particular, such that the spring element is then advantageously integrated in the jacket in a corresponding manner and is preferably also connected to the latter in a materially integral manner. The spring effect of the spring element in this instance is achieved in particular in that the plastics material is initially brought to the envisaged spring shape, is then initially relaxed by temperature controlling, and finally solidifies in the spring shape as the basic shape.

Other features which are considered as characteristic for the invention are set forth in the appended claims. The explanations in the context of the cable herein apply in analogous manner also to the method and to the extrusion unit, and vice versa.

Although the invention is illustrated and described herein as embodied in a cable, method for producing a cable and extrusion unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a cable in a side view;

FIG. 2 shows the cable according to FIG. 1 in a cross-sectional view taken along the line I-I in FIG. 1;

FIG. 3 shows a further cable in a cross-sectional view;

FIG. 4 shows a further cable in a side view;

FIG. 5 shows the cable according to FIG. 4 in a cross-sectional view taken along the line II-II in FIG. 4;

FIG. 6 shows the cable according to FIG. 4 in a bent state, in a side view;

FIG. 7 shows a further cable which is configured as an audio cable;

FIG. 8 shows a further cable which is installed passing through an environment having specific requirements set for the jacket;

FIG. 9 shows a further cable which is installed in the environment of a component;

FIG. 10 shows an extrusion unit for strip-extruding a helical portion;

and

FIG. 11 shows a further extrusion unit having pressure-controlled feed units and a switching element.

### DETAILED DESCRIPTION OF THE INVENTION

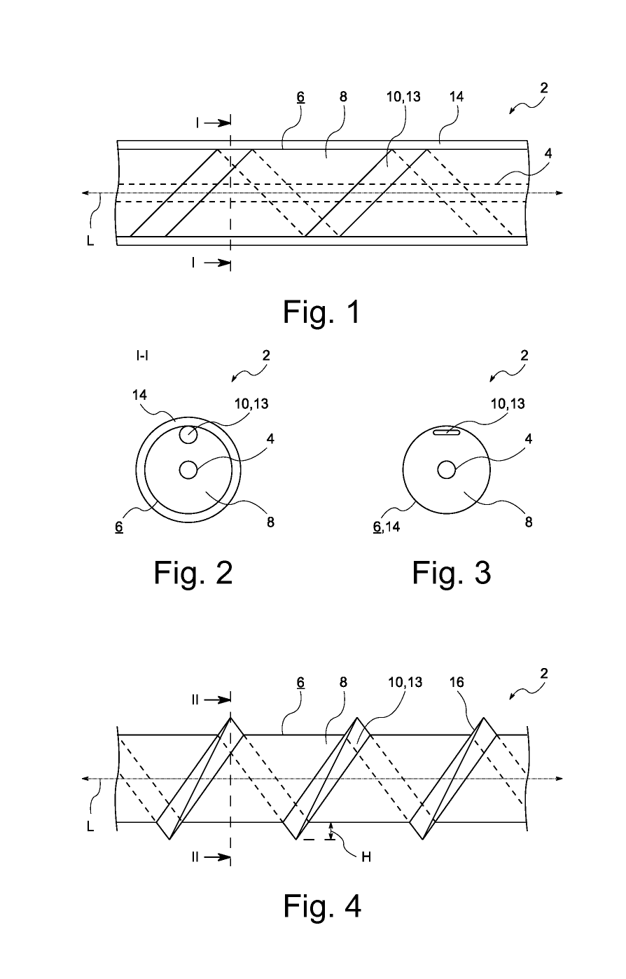

Referring now to the figures of the drawing in detail, various exemplary embodiments of a cable 2 which extends in a longitudinal direction L and has a conductor 4 which is surrounded by a jacket 6 are illustrated in FIGS. 1 to 9. The jacket 6 has a plurality of portions 8, 10, 12 which are made from dissimilar plastics materials and which are extruded onto the conductor 4.

With reference to FIG. 1, there is shown a first exemplary embodiment of the cable 2 in a side view. The embodiment has a total of two portions 8, 10 from dissimilar plastics materials, wherein the one portion 10 as a spring element 13 is produced from one plastics material which is harder than the plastics material used for configuring the other portion 8. The softer plastics material in this instance forms a first portion 8 in which the harder plastics material is embedded as the second portion 10. In the exemplary embodiment shown here, the second portion 10, that is to say presently the spring element 13, is moreover configured in the manner of a helix and in the shape of a helix extends about the conductor 4 and in the longitudinal direction L. On account thereof, the second portion 10 is configured in the manner of a coiled spring having a corresponding spring effect, on account of which the bending elasticity of the entire cable 2 is then set in such a manner that entangling or interlacing of the cable 2 is prevented. A particularly effective entanglement protection is implemented in this instance by the combination of a hard and a soft plastics material.

FIG. 2 shows the cable 2 according to FIG. 1 in a cross-sectional view taken along the line I-I in FIG. 1. The centrally routed conductor 4 and the jacket 6 which completely surrounds the conductor 4 can be clearly seen here. The first portion 8 composed of the softer plastics material here configures an in particular circular cross section of the jacket 6 in which the spring element 13 is embedded. Furthermore, the variant of the cable 2 shown in FIGS. 1 and 2 has an external jacket 14 which is additionally extruded onto the jacket 6 and completely covers the latter.

The second portion 10 as the spring element 13 in FIG. 2 is embodied having a round cross section; however, other design embodiments are also conceivable, for example the strip-shaped design embodiment illustrated in FIG. 3. The variant of the cable 2 shown in FIG. 3 is moreover configured without an additional external jacket 14 such that the jacket 6 by way of the portions 8, 10 is per se the external jacket 14 of the cable 2.

FIG. 4 shows a further variant of the cable 2 in a side view, wherein the second portion 10 which here is configured as the spring element 13 is not completely integrated in the jacket 6 but is constructed on the remaining jacket, that is to say presently on the first portion 8, and herein projects at a height H, measured perpendicularly to the longitudinal direction L. In this way, the second portion 10 configures as a delimitation element 16 that encircles the cable 2 and guarantees a corresponding reinforcement of the cable 2.

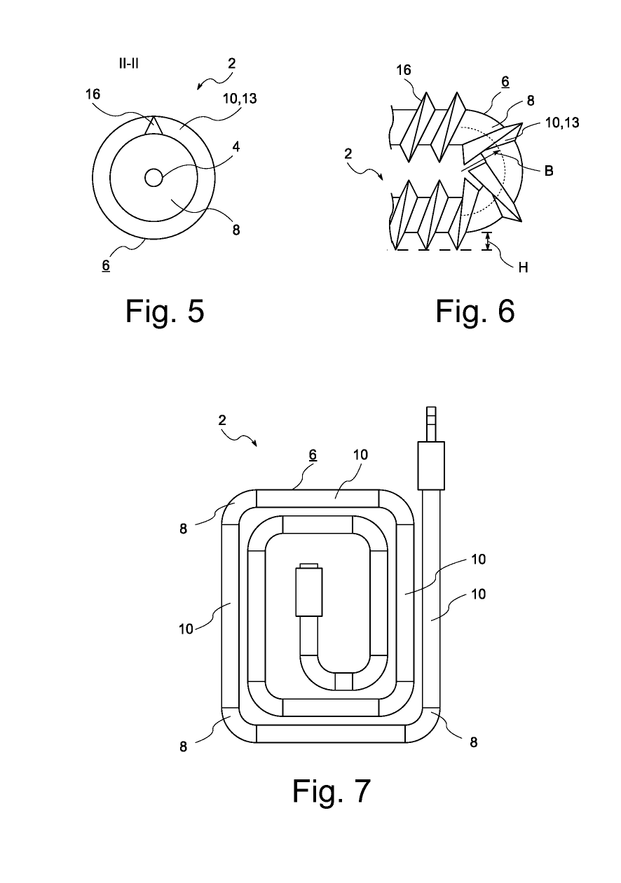

The variant of the cable 2 according to FIG. 4 is illustrated in FIG. 5 in a sectional view, the section being taken along the plane II-II indicated in FIG. 4. The helically encircling second portion 10 and the cross section thereof, presently a triangular cross section, that is constructed in an outward manner on the first portion 8 can be clearly seen herein.

The reinforcing effect of this delimitation element 16 becomes particularly evident in FIG. 6 which shows the cable from FIG. 4 in a flexed illustration. A minimum bending radius B of the cable 2 herein is predefined by the delimitation element 16, said minimum bending radius B being highlighted as an arrow in FIG. 4. The delimitation of the bending radius B is initially achieved in particular in that the delimitation element 16 in the bent state prevents the cable 2 from being excessively flexed. In the extreme case, the dissimilar portions of the delimitation element 16 contact one another and on account thereof prevent further flexing. In a variant (not shown) an in particular soft jacket in which the delimitation elements 16 are then enclosed or integrated is additionally applied.

In principle, it is also possible for a plurality of delimitation elements to be configured in particular as a plurality of not interconnected portions 10 of the jacket 6. In a variant (not shown) a plurality of spring elements 13 are configured in the manner of a helix, for example, said spring elements 13 in this instance in a corresponding manner also configuring a plurality of delimitation elements 16.

FIG. 7 shows a further variant of the cable 2 which presently is configured in particular as an audio or headphone cable. As opposed to the aforementioned variants of the cable 2 having portions 8, 10 that are continuous in the longitudinal direction L, the cable 2 in FIG. 7 has a plurality of portions 8, 10 that are sequentially disposed in the longitudinal direction L and are made from dissimilar plastics materials. The jacket 6 of the cable 2 illustrated here is configured in particular from two dissimilar plastics materials which in an alternating manner are successively disposed in the longitudinal direction L. The first portions 8 in the variant shown here are in each case made from a soft plastics material and in this instance form hinges of the cable 2 where the latter can be bent. By contrast, the second portions 10 that are made from a hard plastics material form in each case longitudinal portions which in comparison to the first portions 8 are flexurally rigid and which correspondingly cannot be bent. A particularly ordered folding-up of the cable 2 is enabled, and entangling or interlacing is prevented in this way.

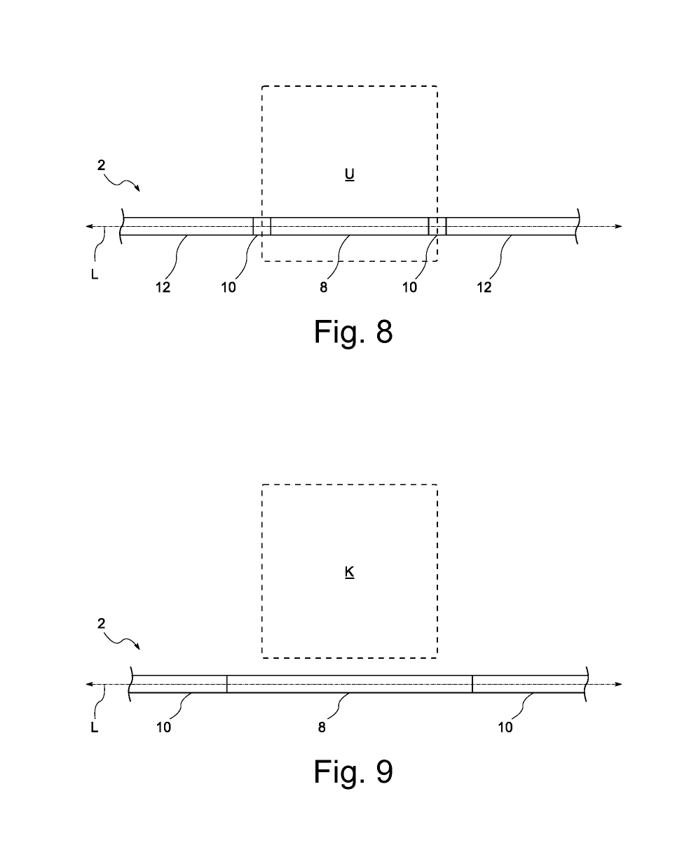

FIG. 8 shows a cable 2 having a plurality of portions 8, 10, 12 which in the longitudinal direction L have been extruded sequentially onto a conductor 4 (not illustrated in more detail). The cable 2 is to be installed in portions in an environment U which sets particular requirements for the jacket 6 of the cable 2. However, there are no special requirements outside this environment U. Such requirements are, for example, a particular electrical shielding of the cable 2 in order to avoid any electromagnetic radiation into the environment U or from the latter into the cable 2, or else a particular media resistance should the environment U contain aggressive substances such as, for example, acids. Alternatively, a particularly high temperature prevails in the environment U such that the cable in the portion 8 that is routed through the environment U is to be particularly temperature-resistant. The respective first portion 8 is therefore made from a correspondingly suitable plastics material which has been selected taking into account the requirements. By contrast, the portions 12 that are outside the environment U are made from another plastics material which does not have to meet the respective requirements and therefore is expediently selected with a view to other criteria.

Additionally, the first portion 8 in FIG. 8 is bordered by two second portions 10 which are disposed in the transition region toward the environment U and are made from sealing plastics materials, for example, should the environment U be in particular encapsulated. In this way, the jacket 6 of the cable 2 shown in FIG. 8 is selectively adapted in an optimal manner to the respective requirements that apply in each case to a specific portion 8, 10, 12. The plastics materials used in each case for configuring the dissimilar portions 8, 10, 12 are selected in a manner corresponding to the requirements that apply to the respective portion 8, 10, 12.

A cable 2 having a plurality of successive portions 8, 10 in the longitudinal direction L is shown in FIG. 9, wherein the cable 2 is to be installed so as to bypass a component K which sets particular requirements for the portion 8 of the cable 2. For example, the component K is a motor of a motor vehicle (not illustrated in more detail) and the portion 8 is to be particularly heat-resistant. Said portion 8 is therefore made from a correspondingly heat-resistant plastics material, whereas the portion 10 that adjoins the portion 8 in the longitudinal direction L are made from a comparatively more cost-effective plastics material which does not need to be heat-resistant.

FIGS. 8 and 9 show only two of the multiplicity of potential exemplary embodiments of the cable 2. In very general terms, the cable 2 comprises a plurality of portions 8, 10, 12 which are disposed sequentially in the longitudinal direction L, wherein the plastics material used in each case for the configuration of said portions 8, 10, 12 is selected with a view to the requirements that are set for the respective portion 8, 10, 12, that is to say with a view to specific main properties of the plastics material. The requirements herein can be in particular physical, chemical, electrical, or mechanical requirements such that a respective plastics material in a corresponding manner can be distinguished by specific chemical, physical, electrical or mechanical properties.

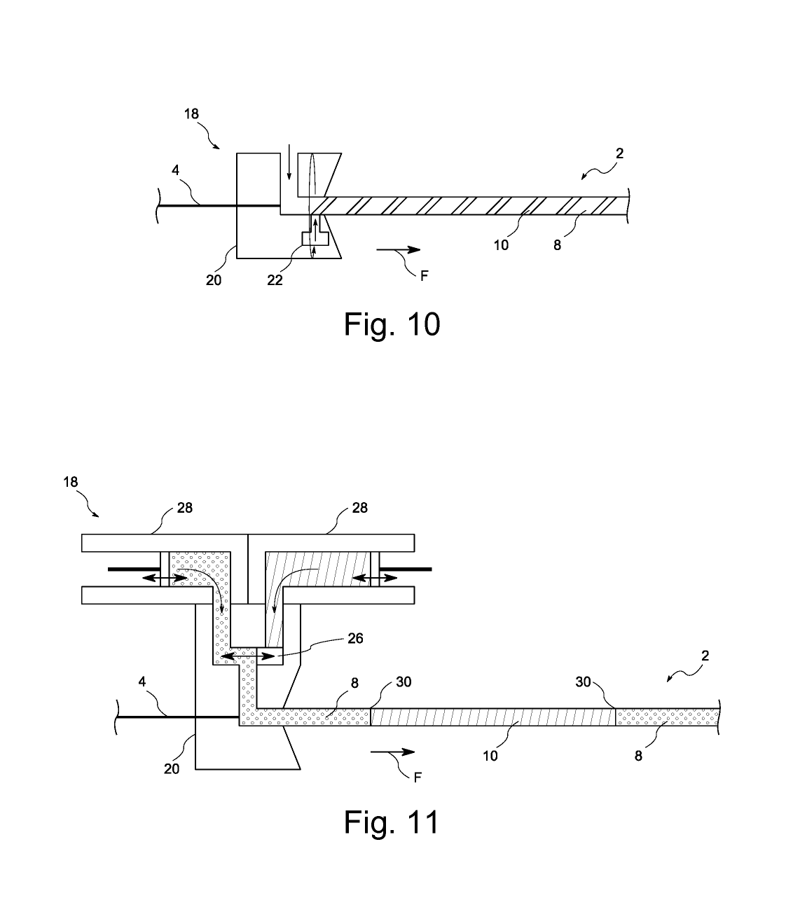

An extrusion unit 18 for producing the cable 2 is shown in each of FIGS. 10 and 11. In each case one conductor 4 onto which a jacket 6 is then extruded is fed in each case to the extrusion unit 18 herein. The cable 2 is in particular continuously conveyed in a conveying direction F such that the jacket 6 is also applied preferably continuously and in particular also universally.

The extrusion unit 18 shown in FIG. 10 serves for configuring a jacket 6 having a plurality of portions 8, 10, wherein the latter are in each case configured continuously and universally. The cable 2 produced in FIG. 10 herein corresponds in particular to the exemplary embodiment already shown in FIG. 1. The extrusion unit 18 for applying the jacket 6 comprises an extrusion head 20 to which a first plastics material is fed in order for the first portion 8 to be configured. The second portion 10 is configured by means of a strip-extrusion head 22 which in the variant shown here is integrated in the extrusion head 20. The strip-extrusion head 22 in operation continuously rotates about the longitudinal axis L in order for the helical shape of the second portion 10 to be configured.

A second extrusion unit 18 which is particularly suitable for continuously configuring a plurality of portions 8, 10 that are sequentially disposed in the longitudinal direction L is illustrated in FIG. 11. In contrast to the extrusion unit 18 of FIG. 10, the extrusion of the various plastics materials herein is not performed continuously but in an alternating and selective manner. To this end the extrusion unit 18 comprises a switching element 24 in order to in each case feed one or some of the plurality of plastics materials to the extrusion head 20. This switching element 24 is presently embodied as a branch having a non-return flap 26 which in a respective position feeds in each case only one of the plastics materials to the extrusion head 20. On account of this particular design embodiment of the switching element 24 as a branch having a non-return flap 26, any mixing of the dissimilar plastics materials during the extrusion is prevented in a particularly efficient manner.

In the case of the extrusion unit 18 of FIG. 11, the material feed is performed by a plurality of feed units 28 which presently are configured as pressure-controlled injection-molding apparatuses. In a variant (not shown) a respective one of the feed units 28 is alternatively a melt pump or an extruder. In this way, the conveyed quantity of a respective feed unit 28 is capable of being metered in a particularly precise manner and is set according to requirements. Depending on the position of the non-return flap 26, that is to say in general depending on the configuration of the switching element 24, the feed unit 28 connected to the extrusion head 20 in a corresponding manner is impinged with a corresponding pressure such that the plastics material that is contained in this feed unit 28 is conveyed into the extrusion head 20 and as the jacket 6 is extruded onto the conductor 4. In switching, the pressure of the one feed unit 28 is then switched off in a corresponding manner such that smooth switching of the switching element 24 is possible. In order for the other plastics material to be conveyed, the other feed unit 28 is then impinged with pressure in a corresponding manner. In this way, particularly clearly defined interfaces 30 are configured along the cable 2 between two successive portions 8, 10. The formation of a mixed zone is particularly avoided on account thereof.

1. A method for producing a cable, the method comprising:
extruding a jacket onto a conductor by way of an extrusion head;
forming the jacket with a plurality of portions that are made from dissimilar plastics materials; and
feeding each of the dissimilar plastics materials by a respective pressure-controlled feed unit having an adjustable conveying quantity.

2. The method according to claim 1, which comprises completely interrupting a feed of one plastics material at an end of a given portion of the jacket and, while avoiding a formation of a mixed zone, subsequently activating a feed of another plastics material for forming a subsequent portion of the jacket.

3. The method according to claim 1, which comprises feeding the dissimilar plastics materials to the extrusion head in an alternating manner by way of a switching element.

4. The method according to claim 1, which comprises:
subjecting a given feed unit to pressure for conveying the plastics material contained in the given feed unit into the extrusion head and extruding the jacket onto the conductor; and
subsequently switching between portions by switching off the pressure to the given feed unit and pressurizing another feed unit for conveying another plastics material into the extrusion head.

5. The method according to claim 1, which comprises providing the dissimilar plastics materials in each case by way of a discontinuously operating feed unit.

6. The method according to claim 1, which comprises switching between the feed units in alternation.

7. The method according to claim 1, wherein the feed unit is an injection-molding apparatus or a melt pump, each without an extruder screw.

8. A cable produced according to a method according to claim 1, the cable comprising:
at least one conductor extending in a longitudinal direction; and
a jacket surrounding said at least one conductor, said jacket being an extrusion jacket extruded onto said at least one conductor and having a plurality of portions made from dissimilar plastics materials.

9. The cable according to claim 8, wherein said plastics materials of two mutually successive portions are not mixed with one another but configure an interface that runs substantially transversely to the longitudinal direction.

10. The cable according to claim 8, wherein at least two of said plastics materials are dissimilar in terms of a hardness thereof.

11. The cable according to claim 8, wherein a plurality of portions are sequentially disposed in the longitudinal direction.

12. The cable according to claim 11, wherein said plurality of portions are alternatively configured as hard portions and soft portions, wherein the soft portions are configured as hinges.

13. The cable according to claim 8, wherein one of said portions is a spring element that extends continuously in the longitudinal direction.

14. The cable according to claim 13, wherein said spring element extends helically along a helix about said conductor.

15. The cable according to claim 13, wherein said spring element is disposed to form a plurality of delimitation elements on an exterior side of said jacket and said delimitation elements pre-define a minimum bending radius of the cable.

16. The cable according to claim 15, wherein one or both of the following is true: said spring element is disposed in an encircling manner, said jacket has a circular cross-section.

17. The cable according to claim 8, which further comprises an exterior jacket surrounding said jacket and covering said jacket outwardly.

18. The cable according to claim 8, wherein said jacket is an exterior jacket.

19. An extrusion unit for carrying out the method according to claim 1, the extrusion unit comprising:
an extrusion head for extruding a stranded product; and
a plurality of feed units for selectively feeding dissimilar plastics materials, said feed units being pressure-controlled feed units for setting a conveying quantity thereof.

20. The extrusion unit according to claim 19 wherein said extrusion head is configured for extruding a jacket for a cable onto a conductor.
